(19) United States
(12) Patent Application Publication
(10) Pub. No.: US 2016/0029053 A1
(43) Pub. Date: Jan. 28, 2016

(54) Method for transmitting media data and virtual desktop server

(71) Applicant: ZTE CORPORATION, Shenzhen, Guangdong (CN)

(72) Inventors: Shijun Zhou, Shenzhen (CN); Yongyin Wang, Shenzhen (CN); Xiang Huang, Shenzhen (CN); Yuwen Ye, Shenzhen (CN)

(21) Appl. No.: 14/774,669

(22) PCT Filed: Aug. 19, 2013
(86) PCT No.: PCT/CN2013/081805

§ 371 Date: Sep. 10, 2015

(30) Foreign Application Priority Data
Mar. 11, 2013 (CN) 201310076742.8

(51) Int. Cl. H04N 21/2343; H04N 21/426; H04N 21/443

(52) U.S. Cl. CPC H04N 21/234309; H04N 21/4437; H04N 21/42615

(57) ABSTRACT

Disclosed is a method for transmitting media data, comprises: acquiring streaming media data of a media file that a terminal requests to play; when it is determined that the terminal supports a media format of the streaming media data, sending the streaming media data to the terminal, and the terminal playing the streaming media data; when it is determined that the terminal does not support the media format of the streaming media data requested to be played, converting the media format of the streaming media data into a media format supported by the terminal; and sending the converted streaming media data to the terminal, and the terminal directly playing the converted streaming media data. Also disclosed is a virtual desktop server. The present invention can effectively save the CPU resources of the virtual desktop server.

### TECHNICAL FIELD

The present disclosure generally relates to virtual desktop technology, and more particularly, to a method for transmitting media data and virtual desktop server.

### BACKGROUND

In recent years, as the rapid development of cloud computing and mobile Internet, the virtual desktop technology becomes more and more popular in enterprise-level applications. Virtual desktop technology allows terminals to access user's desktop through a remote connection software so as to enable simplified management, optimized resource and the like. Virtual desktop technology may make the computer desktop system to be isolated from the local hardware. A terminal may be connected to a virtual desktop server through a network connection so that the calculation logic can be transferred to a virtual desktop server from a local, and then returned by the virtual desktop server to the local, thus enabling unified management of computing resources.

In application of a virtual desktop, if a high-definition video is to be played on the virtual desktop, the following processes are required to be carried out: opening a media file on the virtual desktop by using a media player; capturing the screen of the desktop by the virtual desktop server to obtain image information displayed on the screen; compressing the image information by the virtual desktop server and transmitting the compressed image information to a terminal through network; decompressing and playing the image by the terminal after receiving the compressed image information. However, a large amount of resources of central processing unit (CPU) are occupied by the virtual desktop server in the compressing of image information, and thus the images are displayed slowly, unclear and even unable to be played.

### SUMMARY

In view of above, embodiments of the present disclosure aim to provide a method for transmitting media data and virtual desktop server, which can effectively save the CPU resources of the virtual desktop server.

For this, the technical solution of embodiments of the present disclosure is achieved as follows.

The present disclosure provides a method for transmitting media data. The method includes:

streaming media data of a media file requested by a terminal is acquired; when it is determined that a media format of the streaming media data is supported by the terminal, the streaming media data is transmitted to the terminal, and the terminal plays the streaming media data; when it is determined that the media format of the streaming media data requested to be played is not supported by the terminal, the media format of the streaming media data is converted into a media format supported by the terminal; and the converted streaming media data is transmitted to the terminal, and the terminal plays the converted streaming media data.

In the above solution, the determining whether the media format of the streaming media data is supported by the terminal may include:

media formats of streaming media data that can be supported by the terminal are acquired; when the media formats of streaming media data that can be supported by the terminal includes the media format of the streaming media data requested by the terminal, it is determined that the media format of the streaming media data is supported by the terminal.

In the above solution, when the acquiring of the streaming media data of the media file requested by the terminal fails, the method may further include:

the media file is played, images to be played are compressed into the streaming media data that can be supported by the terminal in a manner of capturing the images, and the compressed streaming media data is transmitted to the terminal, and the terminal decompresses and plays the compressed streaming media data.

In the above solution, when the media format of the streaming media data of the media file is failed to be converted into a media format supported by the terminal, the method may further include:

the media file is played, images to be played are compressed into the streaming media data that can be supported by the terminal in a manner of capturing the images, and the compressed streaming media data is transmitted to the terminal, and the terminal decompresses and plays the compressed streaming media data.

In the above solution, the media format of the streaming media data may include: Advanced Streaming Format (ASF), Widows Media Video (WMV), and Real Media (RM).

An embodiment of the present disclosure provides a virtual desktop server. The virtual desktop server includes a media controller and a first processor; wherein, the media controller is configured to acquire streaming media data of a media file requested by a terminal; when it is determined that a media format of the streaming media data is supported by the terminal, the streaming media data is transmitted to the terminal, and the terminal plays the streaming media data; when it is determined that the media format of the streaming media data requested to be played is not supported by the terminal, the streaming media data is transmitted to the first processor;

the first processor is configured to convert a media format of the streaming media data into a media format supported by the terminal; transmit the converted streaming media data to the terminal; and the converted streaming media data is played by the terminal.

In the above solution, the media controller is further configured to acquire media formats of streaming media data that can be supported by the terminal; when the media formats of streaming media data that can be supported by the terminal includes the media format of the streaming media data requested by the terminal, determine that the media format of the streaming media data is supported by the terminal.

In the above solution, the virtual desktop server further includes a second processor;

the media controller is further configured to, when the acquisition of the streaming media data of the media file requested by the terminal fails, transmit the media file to the second processor;

Correspondingly, the second processor is configured to play the media file, compress images to be played into the streaming media data that can be supported by the terminal in a manner of capturing the images, and transmit the compressed streaming media data to the terminal, and the terminal decompresses and plays the compressed streaming media data.

In the above solution, the first processor is further configured to, when the media format of the streaming media data of the media file is failed to be converted into a media format supported by the terminal, transmit the media file to the second processor;

Correspondingly, the second processor is further configured to play the media file, compress images to be played into the streaming media data that can be supported by the terminal in a manner of capturing the images, and transmit the compressed streaming media data to the terminal, and the terminal decompresses and plays the compressed streaming media data.

In the above solution, the media format of the streaming media data may include ASF, WMV and RM.

The embodiments of the present disclosure provide a virtual desktop server and a method for transmitting media data. The method includes that: by acquiring streaming media data of a media file requested by a terminal, and transmitting the streaming media data to the terminal when it is determined that a media format of the streaming media data is supported by the terminal, the terminal plays the streaming media data directly; when it is determined that the media format of the streaming media data requested to be played is not supported by the terminal, the media format of the streaming media data is converted into a media format supported by the terminal; and the converted streaming media data is transmitted to the terminal, and the terminal directly playing the converted streaming media data. As such, the media data may be transmitted in the format of streaming media data to the terminal for playing. Compared with the prior art, for the streaming media data that can be supported by the terminal, the information on screen is not needed to be captured and compressed, thus the CPU resources of the virtual desktop server can be effectively saved.

### BRIEF DESCRIPTION OF THE DRAWINGS

FIG. 1 is a schematic structure diagram of a virtual desktop server in accordance with an embodiment of the present disclosure;

FIG. 2 is another schematic structure diagram of a virtual desktop server in accordance with an embodiment of the present disclosure;

FIG. 3 is a schematic flowchart of a method for transmitting media data by the virtual desktop server in accordance with an embodiment of the present disclosure.

### DETAILED DESCRIPTION

For more thorough understanding of features and technical content of the present disclosure, the embodiments of the present disclosure are described in further detail below by specific embodiments in conjunction with the accompanying drawings. The accompanying drawings are only illustrative and not intended to limit the embodiments of the present disclosure.

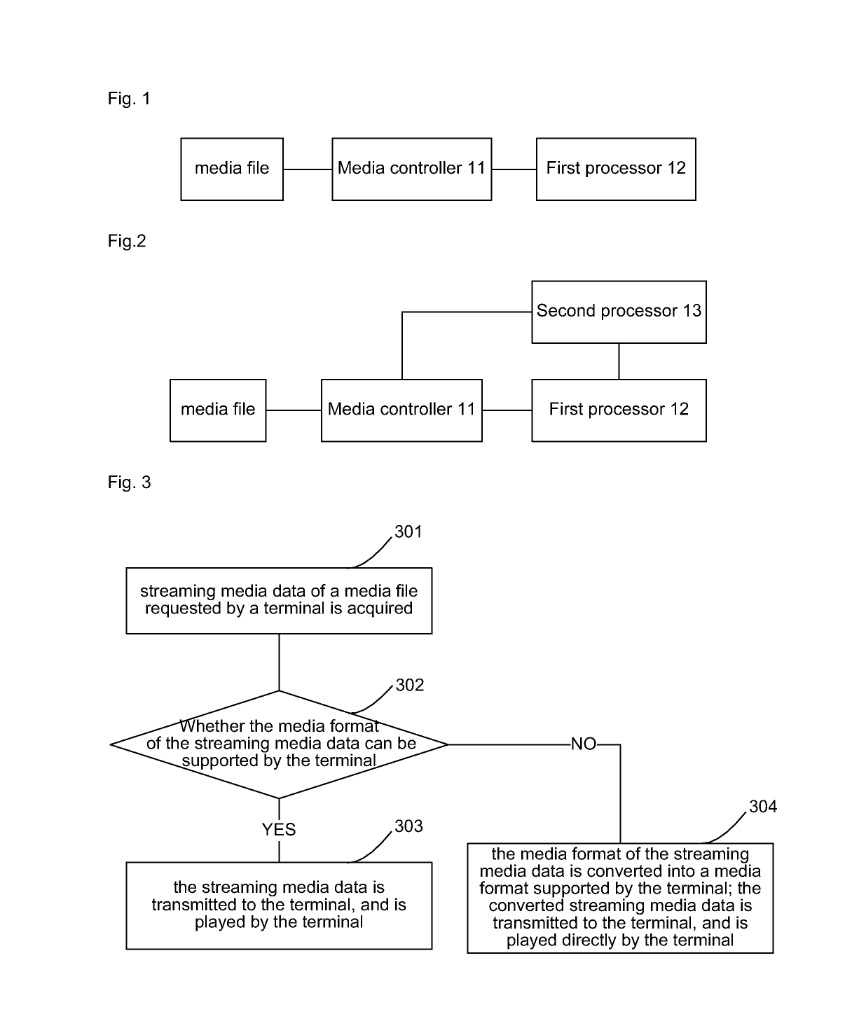

FIG. 1 is a schematic structure diagram of a virtual desktop server in accordance with an embodiment of the present disclosure. As shown in FIG. 1, the virtual desktop server may include a media controller 11, and a first processor 12; wherein,

the media controller 11 is configured to acquire streaming media data of a media file requested by a terminal; when it is determined that a media format of the streaming media data is supported by the terminal, the streaming media data is transmitted to the terminal, and the terminal plays the streaming media data; when it is determined that the media format of the streaming media data requested to be played is supported by the terminal, the streaming media data is transmitted to the first processor 12;

the first processor 12 is configured to convert a media format of the streaming media data into a media format supported by the terminal; transmit the converted streaming media data to the terminal; and the converted streaming media data is played directly by the terminal.

Preferably, the media controller 11 is further configured to acquire media formats of streaming media data that can be supported by the terminal; when the media formats of streaming media data that can be supported by the terminal includes the media format of the streaming media data requested by the terminal, determine that the media format of the streaming media data is supported by the terminal.

Here, the acquiring the media formats of streaming media data that can be supported by the terminal may include:

the virtual desktop server may transmit a request message for acquiring the media format to the terminal; after receiving the request message, the terminal may transmit the media formats of streaming media data that can be supported by the terminal;

alternatively, when the terminal is connected to network, the terminal may automatically report the media formats of streaming media data that can be supported by itself to the virtual desktop server;

alternatively, the media formats of streaming media data that can be supported by the terminal may be stored on the virtual desktop server as registration information or subscription information.

In practice, the media controller 11 and the first processor 12 in the virtual desktop server shown in FIG. 1 may be implemented by a Central Processing Unit (CPU), a Digital Signal Processor (DSP), or a Field Programmable Gate Array (FPGA) in the virtual desktop server.

Preferably, as shown in FIG. 2, on the basis of the virtual desktop server shown in FIG. 1, the virtual desktop server may further include a second processor 13;

the media controller 11 is further configured to, when the acquisition of the streaming media data of the media file requested by the terminal fails, transmit the media file to the second processor 13;

Correspondingly, the second processor 13 is further configured to play the media file, compress images to be played into the streaming media data that can be supported by the terminal in a manner of capturing the images, transmit the compressed streaming media data to the terminal, and the terminal decompresses and plays the compressed streaming media data;

Preferably, the first processor 12 is further configured to, when the media format of the streaming media data of the media file is failed to be converted into a media format supported by the terminal, transmit the media file to the second processor 13;

Correspondingly, the second processor 13 is further configured to play the media file, compress images to be played into the streaming media data that can be supported by the terminal in a manner of capturing the images, transmit the compressed streaming media data to the terminal, and the terminal decompresses and plays the compressed streaming media data.

In the above solution, the media file may be stored in the virtual desktop server.

In the above solution, the streaming media data may be media data that can be transmitted and played in a form of streaming.

In the above solution, the media format of the streaming media data may include ASF, WMV and RM.

In the above solution, the media formats that can be supported by the terminal may be media formats that can be played by the terminal, such as WMV and RM.

In the above solution, the capturing of images may include that the pixel information for each frame of the image displayed on the screen is acquired when the media file is played.

In practice, the media controller 11, the first processor 12 and the second processor 13 in the virtual desktop server shown in FIG. 2 may be implemented by a CPU, a DSP, or a FPGA in the virtual desktop server.

FIG. 3 is a schematic flowchart of a method for transmitting media data by a virtual desktop server in accordance with an embodiment of the present disclosure. As shown in FIG. 3, the method may include:

step 301: streaming media data of a media file requested by a terminal is acquired.

Here, the media file may be stored in the virtual desktop server.

Here, the streaming media data may be media data that can be transmitted and played in a form of streaming.

Preferably, step 301 may further include that: when the virtual desktop server fails to acquire the streaming media data of the media file requested by the terminal, the media file is played, images to be played are compressed into the streaming media data that can be supported by the terminal in a manner of capturing the images, and the compressed streaming media data is transmitted to the terminal, and the terminal decompresses and plays the compressed streaming media data.

Here, the capturing of images may include that the pixel information for each frame of the image displayed on the screen is acquired when the media file is played.

Here, the media formats that can be supported by the terminal may be media formats that can be played by the terminal, such as WMV and RM.

Step 302: it is determined whether the media format of the streaming media data can be supported by the terminal; if the media format can be supported by the terminal, step 303 may be performed; otherwise, step 304 may be performed.

Here, the media format of the streaming media data may include ASF, WMV, and RM.

Here, the determining whether the media format of the streaming media data can be supported by the terminal may include:

the virtual desktop server may acquire the media formats of streaming media data that can be supported by the terminal; when the media formats of streaming media data that can be supported by the terminal includes the media format of the streaming media data requested by the terminal, it is determined that the media format of the streaming media data can be supported by the terminal; and when the media formats of streaming media data that can be supported by the terminal does not include the media format of the streaming media data requested by the terminal, it is determined that the media format of the streaming media data cannot be supported by the terminal.

Here, the acquiring the media formats of streaming media data that can be supported by the terminal may include:

the virtual desktop server may transmit a request message for acquiring the media format to the terminal; after receiving the request message, the terminal may transmit the media formats of streaming media data that can be supported by the terminal;

alternatively, when the terminal is connected to network, the terminal may automatically report the media formats of streaming media data that can be supported by itself to the virtual desktop server;

alternatively, the media formats of streaming media data that can be supported by the terminal may be stored on the virtual desktop server as registration information or subscription information.

Step 303: the streaming media data is transmitted to the terminal, and is played by0 the terminal.

Step 304: media format of the streaming media data is converted into a media format supported by the terminal; the converted streaming media data is transmitted to the terminal; and the converted streaming media data is played directly by the terminal.

Preferably, step 304 may further include that: when the media format of the streaming media data is failed to be converted into the media formats that can be support by the terminal, the virtual desktop server plays the media file, compresses images being played into the streaming media data that can be supported by the terminal in a manner of capturing the images, transmits the compressed streaming media data to the terminal, and the terminal decompresses and plays the compressed streaming media data.

The above description is only a preferred embodiment of the present disclosure, and is not intended to limit the scope of the present disclosure.

### INDUSTRIAL APPLICABILITY

The present disclosure provides a method for transmitting media data and a virtual desktop server. The method includes that: when it is determined that media format of streaming media data of a media file that is requested to play can be supported by a terminal, the streaming media data is received and played directly by the terminal; when it is determined that media format of streaming media data of a media file that is requested to play cannot be supported by a terminal, the media format of the streaming media data is converted into a media format that can be supported by the terminal, and then the converted streaming media data is received and played by the terminal. As such, media files may be transmitted in a format of streaming media data to the terminal for playing, thus the CPU resources of the virtual desktop server can be effectively saved.

1. A method for transmitting media data, comprising:
acquiring streaming media data of a media file requested by a terminal;
when it is determined that a media format of the streaming media data is supported by the terminal, transmitting the streaming media data to the terminal and playing the streaming media data by the terminal;
when it is determined that the media format of the streaming media data is not be supported by the terminal, converting the media format of the streaming media data into a media format supported by the terminal, transmitting the converted streaming media data to the terminal, and playing the converted streaming media data by the terminal.

2. The method according to claim 1, wherein the determining that the media format of the streaming media data is supported by the terminal comprises:
acquiring media formats of streaming media data that can be supported by the terminal;
when the media formats of streaming media data that are supported by the terminal comprises the media format of the streaming media data requested by the terminal, it is determined that the media format of the streaming media data is supported by the terminal.

3. The method according to claim 1, wherein when the acquiring the streaming media data of the media file requested by the terminal fails, the method further comprises:
playing the media file, compressing images being played into streaming media data that can be supported by the terminal in a manner of capturing the images, and transmitting the compressed streaming media data to the terminal, and decompressing and playing the compressed streaming media data by the terminal.

4. The method according to claim 1, wherein when the converting the media format of the streaming media data into the media format supported by the terminal fails, the method further comprises:
playing the media file, compressing images being played into streaming media data that can be supported by the terminal in a manner of capturing the images, and transmitting the compressed streaming media data to the terminal, and decompressing and playing the compressed streaming media data by the terminal.

5. The method according to claim 1, wherein the media format of the streaming media data comprises: Advanced Streaming Format (ASF), Widows Media Video (WMV), and Real Media (RM).

6. A virtual desktop server, comprising a media controller and a first processor; wherein,
the media controller is configured to acquire streaming media data of a media file requested by a terminal; when it is determined that a media format of the streaming media data is supported by the terminal, transmit the streaming media data to the terminal, and the streaming media data is played by the terminal; when it is determined that the media format of the streaming media data is not supported by the terminal, transmit the streaming media data to the first processor;
the first processor is configured to convert a media format of the streaming media data into a media format supported by the terminal; transmit the converted streaming media data to the terminal; and the converted streaming media data is played by the terminal.

7. The virtual desktop server according to claim 6, wherein the media controller is further configured to acquire media formats of streaming media data that can be supported by the terminal; when the media formats of streaming media data that can be supported by the terminal comprises the media format of the streaming media data requested by the terminal, it is determined that the media format of the streaming media data is supported by the terminal.

8. The virtual desktop server according to claim 6, wherein the virtual desktop server further comprises a second processor;
the media controller is further configured to, when the acquisition of the streaming media data of the media file requested by the terminal fails, transmit the media file to the second processor;
the second processor is configured to play the media file, compress images being played into the streaming media data that is supported by the terminal in a manner of capturing the images, and transmit the compressed streaming media data to the terminal, and the compressed streaming media data is decompressed and played by the terminal.

9. The virtual desktop server according to claim 8, wherein,
the first processor is further configured to, when the media format of the streaming media data of the media file is failed to be converted into a media format supported by the terminal, transmit the media file to the second processor;
the second processor is further configured to play the media file, compress images being played into the streaming media data that is supported by the terminal in a manner of capturing the images, and transmit the compressed streaming media data to the terminal, and the compressed streaming media data is decompressed and played by the terminal.

10. The virtual desktop server according to claim 6, wherein the media format of the streaming media data comprises:
Advanced Streaming Format (ASF), Widows Media Video (WMV) and Real Media (RM).

11. The method according to claim 2, wherein the media format of the streaming media data comprises: Advanced Streaming Format (ASF), Widows Media Video (WMV), and Real Media (RM).

12. The method according to claim 3, wherein the media format of the streaming media data comprises: Advanced Streaming Format (ASF), Widows Media Video (WMV), and Real Media (RM).

13. The method according to claim 4, wherein the media format of the streaming media data comprises: Advanced Streaming Format (ASF), Widows Media Video (WMV), and Real Media (RM).

14. The virtual desktop server according to claim 7, wherein the media format of the streaming media data comprises: Advanced Streaming Format (ASF), Widows Media Video (WMV) and Real Media (RM).

15. The virtual desktop server according to claim 8, wherein the media format of the streaming media data comprises: Advanced Streaming Format (ASF), Widows Media Video (WMV) and Real Media (RM).

16. The virtual desktop server according to claim 9, wherein the media format of the streaming media data comprises: Advanced Streaming Format (ASF), Widows Media Video (WMV) and Real Media (RM).
